(19) United States
(12) Patent Application Publication
(10) Pub. No.: US 2016/0177624 A1
(43) Pub. Date: Jun. 23, 2016

(54) LOW HEADROOM CURTAIN RISER FOR A ROLL-UP DOOR, AND ROLL-UP DOOR USING THE SAME

(71) Applicant: INDOTECH INDUSTRIAL DOORS INC., Boucherville (CA)

(72) Inventors: Juan PALENCIA, Montreal (CA); Daniel DELAND, Longueuil (CA); Don MCTAVISH, Boucherville (CA)

(21) Appl. No.: 14/573,786

(22) Filed: Dec. 17, 2014

(51) Int. Cl. E06B 9/58; E06B 9/68

(52) U.S. Cl. CPC E06B 9/581; E06B 9/68

(57) ABSTRACT

A roll-up door and a curtain riser for a roll-up door are disclosed. The roll-up door includes a curtain, a pair of lateral guides configured to hold sides of the curtain when lowered, and a curtain riser. The curtain riser includes a horizontal member on which the curtain can be rolled when raised. A front edge of the horizontal member is aligned with a path formed by the lateral guides so that a top end of the curtain is tangent to the horizontal member when the curtain is fully lowered. The disclosed configuration of the curtain riser allows installation of the roll-up doors in applications where low headroom is available.

### TECHNICAL FIELD

The present disclosure relates to the field of door systems. More specifically, the present disclosure relates to low headroom curtain riser for a roll-up door and to a roll-up door having the low headroom curtain riser.

### BACKGROUND

Roll-up doors offer wide flexibility in terms of sizes and the capability of undergoing large numbers of fast opening and closing cycles in a single day. They are used, predominantly in commercial and industrial applications. These doors usually comprise a large curtain made of a flexible material, for example rubber, supported by guides on each side of a door frame.

US Patent Publication no 201 3/0158313 A1, dated Jun. 12 2014, to McTavish et al., the disclosure of which is incorporated by reference herein, discloses a deformable lateral guide for a roll-up door having a curtain whose edges are configured for operation with a deformable lateral guide. An embodiment of the deformable lateral guide is shown on FIG. 1, which is a top cross-sectional view of a vertical side strip of a door curtain interacting with a vertical guide. A vertical guide 10 is adapted to operate with a vertical side strip 12 attached to a side edge of a curtain 14. The vertical guide 10 comprises a first vertical guide portion 16 and a second vertical guide portion 18 having respective series of threaded holes 20 and 22 for attachment to a doorway frame (not shown) using bolts such as 24. In a particular embodiment, the first vertical guide portion 16 has a thinner cross-section 26 when compared to a cross-section 28 of the second vertical guide portion 18.

The first vertical guide portion 16 is biased against a series of cylindrical, inner projections 30 of the second vertical guide portion 18 by a biasing element, for example a series of springs 32. Each cylindrical projection 30 is threaded on its internal surface.

The first vertical guide portion 16 comprises a non-threaded hole 34 in alignment with the cylindrical projection 30. Each spring 32 is mounted onto a bolt 36 between an outer surface 38 of the first vertical guide portion 16 and a head 40 of the bolt 36. The bolt 36 is threaded into the internally threaded cylindrical projection 30 through the hole 34.

In normal operation, the springs 32 maintains the first vertical guide portion 16 in a rest position against the projection 30 of the second vertical guide portion 18, as shown on FIG. 1. While in the rest position, the first vertical guide portion 16 forms, with the second vertical guide portion 18, a longitudinal slot 42 for receiving a link 44 of the vertical side strip 12 between a U-shaped longitudinal portion 46 attached to the curtain 14 and a generally trapezoidal longitudinal rib 48.

Under excessive wind load or impact conditions, the vertical guide 10 is deformed by moving the first vertical guide portion 16 away from the second vertical guide portion 18, compressing the springs 32, thereby widening the longitudinal slot 42 to allow the longitudinal rib 48 first, and then a shifted wall section 50, to pass through the longitudinal slot 42 to release the vertical side strip 12 from the vertical guide 10. The predetermined threshold for releasing the vertical side strip 12 under excessive wind load or under impact may be adjusted by proper selection of material for making the vertical guide 10, by proper selection of the geometry, thickness and size configurations of the various elements of the vertical guide 10, and by a number and a level of resilience of the springs 32.

Roll-up doors may be at once quite wide and high. When rolled up and wrapped around a horizontal rod, tube or like elongated structure, their curtains form a thick roll that, together with mechanical structures designed for holding and rolling up and down the curtains, occupies significant space above the open door frame, usually underneath a ceiling or underneath some other overhead infrastructure. In the particular case illustrated in FIG. 1, a thickness of the roll is to a large extent determined by overlap of the vertical side strip 12, especially at the longitudinal rib 48 and at the shifted wall section 50. The vertical space, called headroom, that is available between the top of the door frame and the ceiling or other overhead infrastructure is oftentimes quite limited.

Therefore, there is a need for a low headroom roll-up door system.

### SUMMARY

According to the present disclosure, there is provided a roll-up door. The door includes a curtain, a pair of lateral guides configured to hold sides of the curtain when lowered, and a horizontal member on which the curtain can be rolled when raised. A front edge of the horizontal member is aligned with a path formed by the lateral guides so that a top end of the curtain is tangent to the horizontal member when the curtain is fully lowered.

The present disclosure further relates to a low headroom curtain riser for a roll-up door having a curtain and a pair of lateral guides for the curtain. The curtain riser includes a horizontal member on which the curtain can be rolled when raised. A front edge of the horizontal member being aligned with a path formed by the lateral guides so that a top end of the curtain is tangent to the horizontal member when the curtain is fully lowered.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a top cross-sectional view of a vertical side strip of a door curtain interacting with a vertical guide;

FIG. 2 is a rear elevation view of a door frame on which a roll-up door is to be mounted;

FIG. 3 is a rear elevation view of a roll-up door according to an embodiment;

FIG. 4 is a rear perspective view of the roll-up door of FIG. 3;

FIG. 5 is a side elevation view of the roll-up door of FIG. 3;

FIG. 6 is a top view of the roll-up door of FIG. 3;

FIG. 7 is a cross-sectional, side elevation view of the roll-up door of FIG. 3;

FIG. 8 is a detailed view from FIG. 7, showing an interaction of a roll-up curtain with a horizontal member and with a curtain deflector;

FIG. 9 is a detailed, cross-sectional view taken along line B-B of FIG. 7, showing an interaction of the roll-up curtain with a lateral guide; and

FIG. 10 is a detailed view of the bottom of the roll-up door of FIG. 3.

Like numerals represent like features on the various drawings.

### DETAILED DESCRIPTION

Various aspects of the present disclosure generally address one or more of the problems related to the low amount of available headroom for installation of roll-up door systems.

In conventional roll-up doors, an idler aligns a flexible curtain of the door in its path as it moves up and down between a pair of lateral guides. This idler takes up significant headroom.

In an embodiment of the present disclosure, the idler is removed. The curtain is roll-up on a horizontal member positioned lengthwise above a frame of the door, higher than a top of the opening of the door frame. A front edge of the horizontal member is generally aligned with a path of the curtain formed by the lateral guides so that a top end of the curtain is tangent to the horizontal member when fully lowered. This configuration allows the door to operate without any idler, thereby reducing the required headroom between the top of the door frame and the ceiling or other overhead structure. When fully raised, the curtain is rolled onto the horizontal member. Evidently, a combination of the horizontal member and of the rolled curtain has a larger diameter than a diameter of the horizontal member. A curtain deflector positioned at a forward angle from a top of the lateral guides and slightly lower than a rolling axis of the horizontal member ensures that the curtain is directed toward the lateral guides as it is lowered.

The curtain may be terminated at its bottom by a horizontal bottom bar that can be retrieved fully between the horizontal member and the curtain deflector when the curtain is fully raised. In this way, the horizontal bottom bar can be fully hidden as seen from outside of the door, completely freeing the open space of the door frame when the door is rolled up. This configuration does not add to the required headroom.

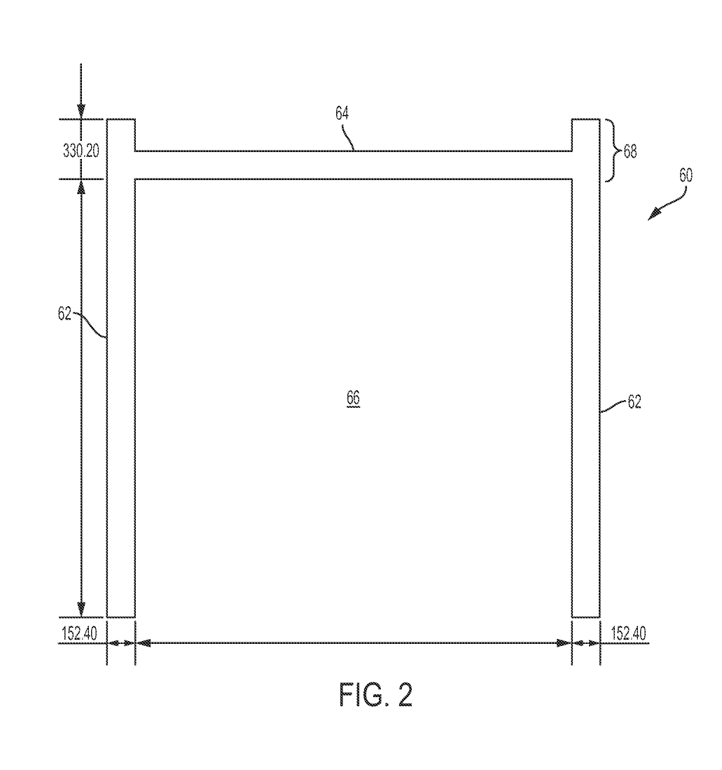

Referring now to the drawings, FIG. 2 is a rear elevation view of a door frame on which a roll-up door is to be mounted. A door frame 60 is formed of two (2) vertical studs or beams 62 and a top, horizontal stud or beam 64. As shown, the vertical beams 62 extend beyond a height of an open area 66 formed within the door frame 60. This height extension of the vertical beams 62 provide an available headroom 68 where a riser system for the roll-up door can be installed. Without limitation, the headroom 68 as shown measures 330.20 mm, or 13 inches. Generally, the construction of the door frame 60 as well as its measurements, including the shown width (152.40 mm) of the vertical beams 62, do not impact the teachings of the present disclosure. The beams 62 and 64 may be substituted by edges of a wall. Details of the door frame 60 are provided for purposes of illustration and do not limit the present disclosure.

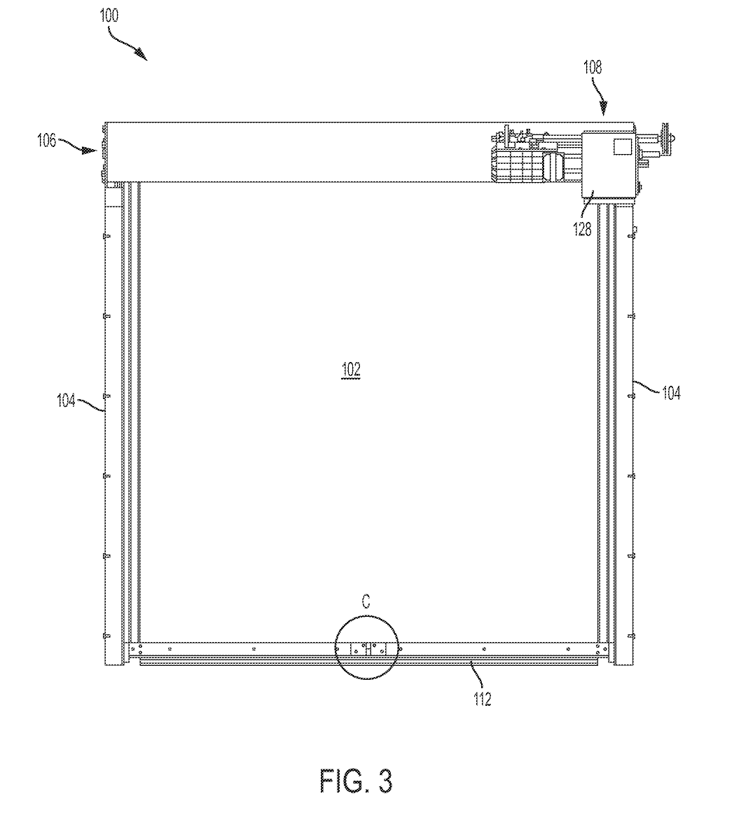

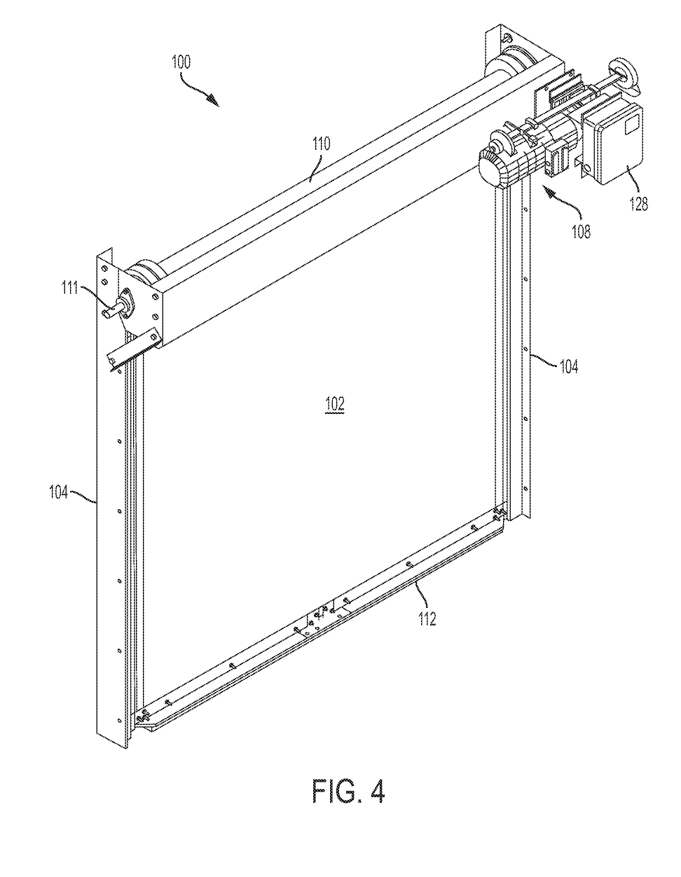

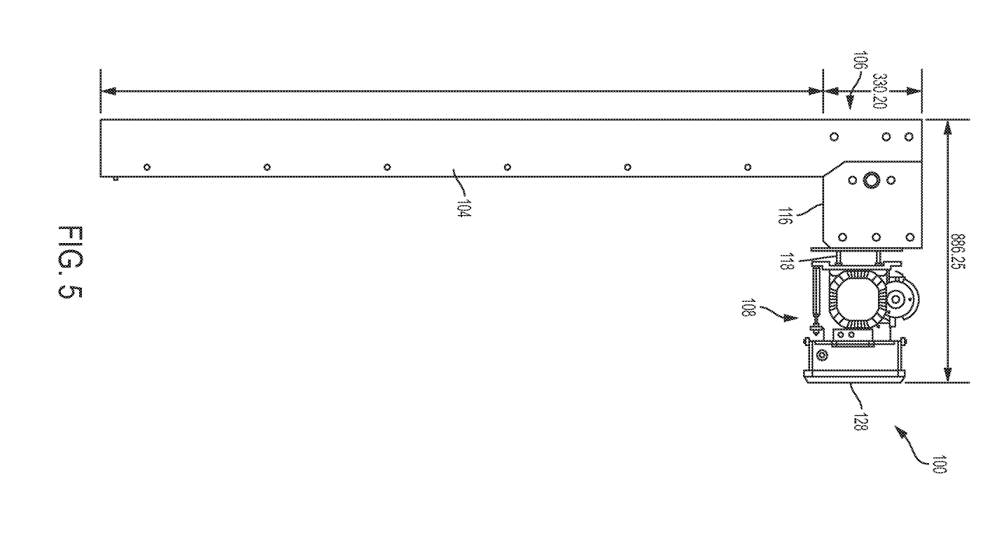

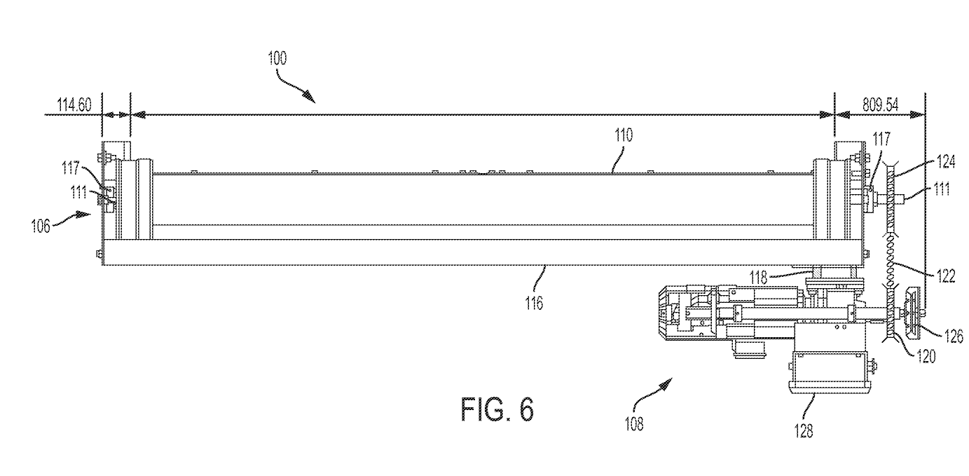

FIG. 3 is a rear elevation view of a roll-up door according to an embodiment. FIG. 4 is a rear perspective view of the roll-up door of FIG. 3. FIG. 5 is a side elevation view of the roll-up door of FIG. 3. FIG. 6 is a top view of the roll-up door of FIG. 3. Referring at once to FIGS. 3, 4, 5 and 6, a roll-up door 100 can be mounted on the door frame 60. In an embodiment, the roll-up door 100 is configured so that the open area 66 of the door frame 60 is fully cleared when the roll-up door 100 is fully opened.

The roll-up door 100 comprises a curtain 102, a pair of lateral guides 104 configured to hold sides of the curtain 102 when lowered, and a curtain riser 106. The curtain riser 106 includes a standard motorized drive 108 operably connected to a horizontal member 110 on which the curtain 102 can be rolled when raised. The horizontal member 110 may for example comprise a hollow tube, a rod, or the like, and generally has a circular cross-section to facilitate rolling of the curtain 102. The curtain 102 may terminate on a lower horizontal bar 112.

As best seen on FIG. 6, the motorized drive 108 is mounted to a frame 116 of the curtain riser 106 by use of bolts 118. The horizontal member 110 is also supported by the frame 116, projections 111 at both ends of the horizontal member 110 being received in bearings 117 mounted at both lateral ends of the frame 116. The motorized drive 108 includes a sprocket 120 driving a chain 122 that in turn engages a sprocket 124 mounted to one of the projections 111 of the horizontal member 110, for rising and lowering the curtain 102. A further sprocket 126 may be mounted to the motorized drive 108 for mounting thereon a chain (not shown) allowing operation of the roll-up door 100 in case of a power failure. A controller 128 of the motorized drive 108 controls rising and lowering operations of the curtain 102. One or more sensors (not shown), including without a motion sensor or a photocell provide signals to the controller 128 for safe operation of the roll-up door 100.

The roll-up door 100 and its components further include various details such as bolts and other attachments, braces, and the like. These are believed to be self-explanatory and do not require additional detailed explanation.

In an example of realization, the curtain 102 may be a laminated curtain comprising layers of various materials, for example flexible recycled rubber material or similar material, and woven or non-woven fiberglass or nylon fibers, the layers being appropriately adhered to each other using a suitable adhesive to form the laminated curtain 102. Suitable adhesives may comprise, without limitation, silicone, styrene, polyurethane, isocyanate, organic adhesives, polymers, acrylics, epoxies, hot melts, and the like. The lateral guides 104, the curtain riser 106 and its frame 116 as well as the horizontal member 110 may be manufactured using a variety of materials including, without limitation steel, for example regular high grade steel such as grade W44 steel, aluminum, chromadium, and the like. Distinct materials may be used for distinct parts of the roll-up door 100.

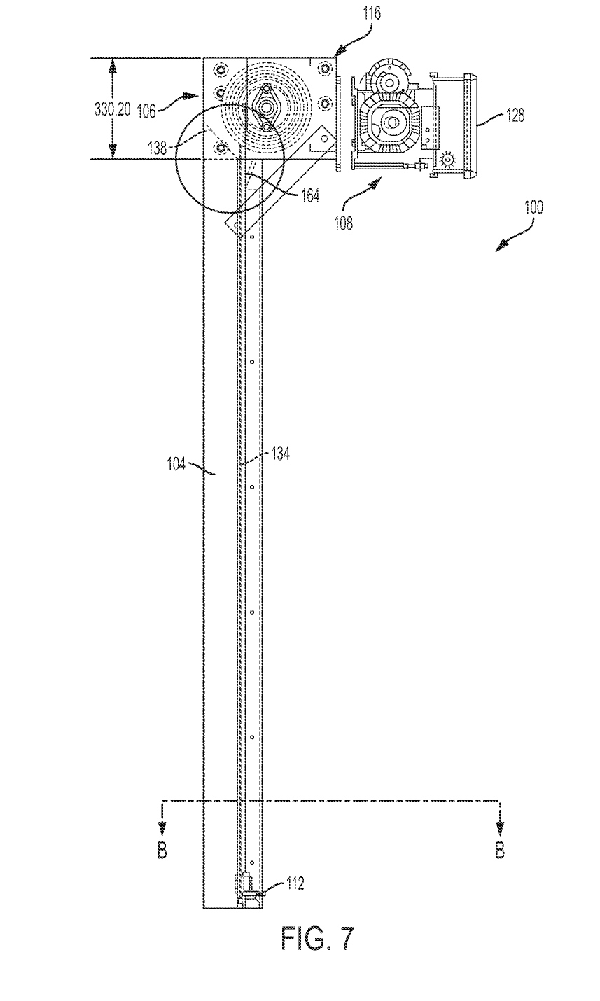

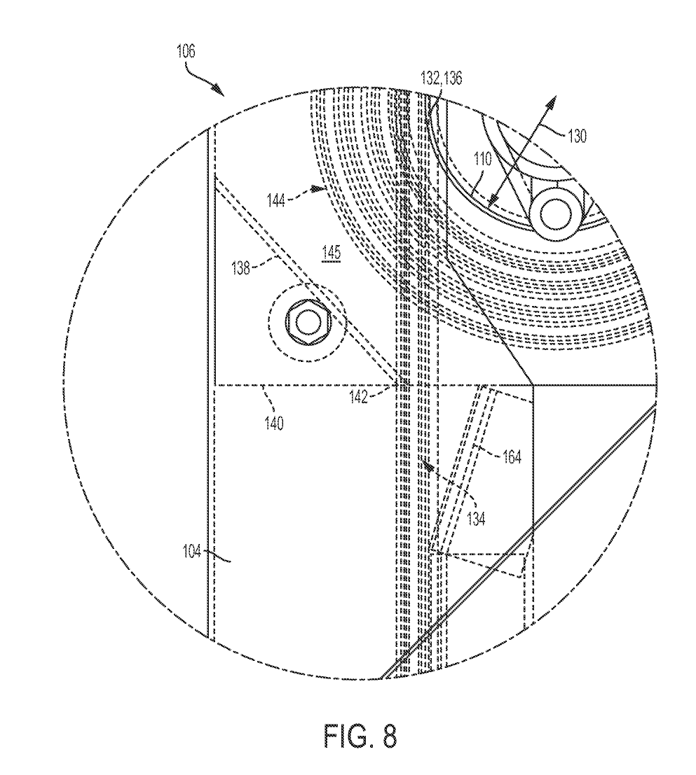

FIG. 7 is a cross-sectional, side elevation view of the roll-up door of FIG. 3. FIG. 8 is a detailed view from FIG. 7, showing an interaction of a roll-up curtain with a horizontal member and with a curtain deflector. As best seen on FIG. 8, a radius 130 of the horizontal member 110 as well as its position within the curtain riser 106 are selected so that a front edge 132 of the horizontal member 110 is substantially aligned with a path 134 of the curtain 102 formed by the lateral guides 104. A top end 136 of the curtain 102 is substantially tangent to the horizontal member 110 when fully lowered.

Also shown on FIGS. 7 and 8, a curtain deflector 138 may be mounted above an opening of the frame 60, more specifically at or above a level of a bottom edge 140 of the horizontal beam 64 of FIG. 2. The curtain deflector 138 is mounted within the curtain riser 106, inclined at a forward angle in relation to a top end 142 of the lateral guides 104. In the context of the present disclosure, the expression ‘forward angle’ is meant to express that the curtain deflector 138 is angled toward the exterior side of the roll-up door 100, in relation to the top end 142 of the lateral guides 104 extends. At least a major part of the curtain deflector 138 is at a position lower than a rolling axis of the horizontal member. One function of the curtain deflector 138 is to direct the curtain 102 as it moves between the lateral guides 104 and an outer diameter 144 formed by partial rolling of the curtain 102 onto the horizontal member 110.

Space 145 is provided between the horizontal member 110 and the curtain deflector 138 so that the horizontal bar 112 may be retrieved between the horizontal member 110 and the curtain deflector 138 when the curtain 102 is fully raised. Otherwise stated, when the outer diameter 144 reaches its maximum because of complete rolling of the curtain 102 on the horizontal member, there is still sufficient space 145 between the curtain deflector 138 and this maximum outer diameter 144 for receiving the horizontal bar 112. In this manner, the horizontal bar 112 rises above the bottom edge 140 of the horizontal beam 64 so that the open area 66 of the door frame 60 is completely unobstructed.

Of course, for applications that do not require that the open area 66 be entirely unobstructed, the curtain riser 106 and the curtain deflector 138 may be configured differently, for example allowing the horizontal bar 112 to hang at a position lower than the bottom edge 140 of the horizontal beam 64 when the curtain 102 is fully raised.

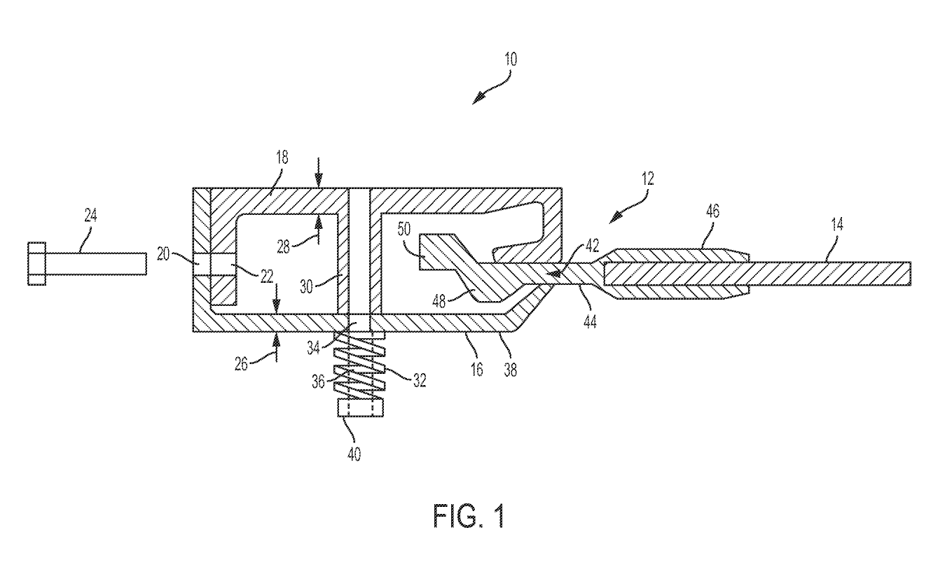

As an example of a particular configuration that does not limit the present disclosure, a curtain 102 extends to a height of 9 feet and 6 inches (114 inches). The maximum thickness of the curtain 102 at its edges (see FIG. 1) in on the order of about one (1) inch. The horizontal member 110 is a tube having 6 inches in diameter, for a circumference of about 18.8 inches. Rolling up the curtain 102 forms six (6) layers on the tube, given its circumference, adding no more than 7 inches to the diameter of the tube, for a total outer diameter 144 not exceeding 13 inches. Using a larger tube, with a diameter of 8 inches, for a circumference of about 25.1 inches, rolling the full curtain forms 4.5 layers on the tube, adding no more than 5 inches to the diameter of the tube, for a total outer diameter 144 not exceeding 13 inches. In both cases, a 13-inch headroom is sufficient for installing the curtain riser 106. A 6-inch tube can accommodate a curtain 102 having a width up to 21 feet while an 8-inch tube can accommodate a curtain 102 having a width up to 40 feet. Of course, other configurations may be used, for other door dimensions and for other available headroom values.

In the above examples, a suitably configured horizontal bar 112 can be hidden in the space 145 between the curtain deflector 138 and the horizontal member 110.

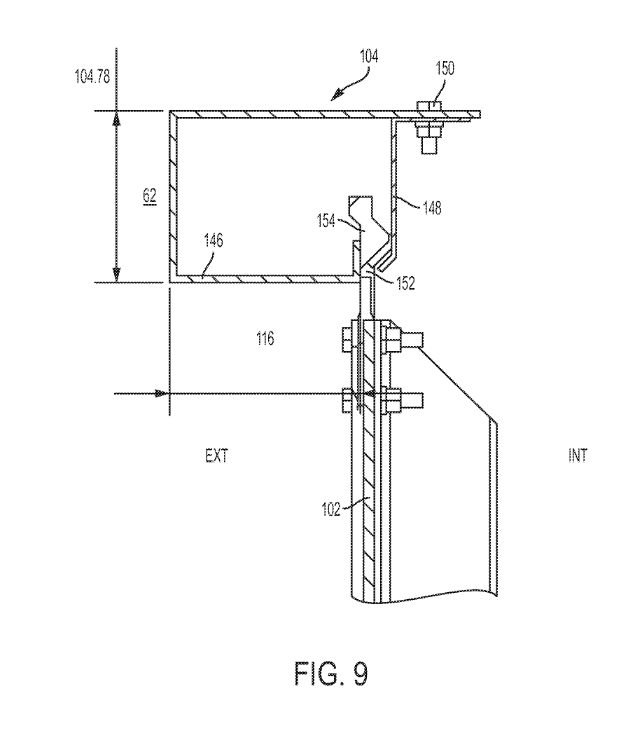

FIG. 9 is a detailed, cross-sectional view taken along line B-B of FIG. 7, showing an interaction of the roll-up curtain with a lateral guide. In a variant of the present disclosure as shown on FIG. 9, the lateral guides 104 may be deformable in a manner as taught in US Patent Publication no 2013/0158313 A1. The lateral guides 104 (one of which is shown) are mounted on the frame 60, on internal faces of the beams 62 using suitable fasteners (not shown), for example nails, screws or bolts. Each lateral guide 104 comprises two (2) complementary vertical guide portions 146 and 148, connected by a series of bolt and nut assemblies 150 and forming an elongated slot 152. Edges 154 of the curtain 102 are releaseably mounted to the lateral guides 104 via the elongated slots 152. In this variant, the curtain 102 may be released from one or both of its lateral guides 104 upon application thereon of a force exceeding a predetermined threshold. When compared to the vertical guide 10 of FIG. 1, the lateral guides 104 are simpler. This simplification is facilitated by the fact that the curtain 102 moves up and down without significant tension, being directed in its path 134 by the configuration of the curtain riser 106. This configuration of the lateral guides 104 in combination with the curtain riser 106 allows operation of the roll-up door 100 without the use of an idler.

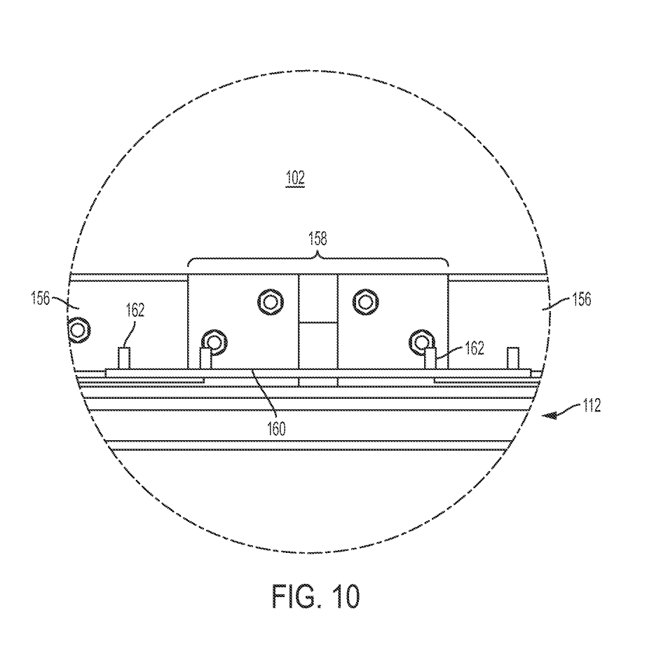

FIG. 10 is a detailed view of the bottom of the roll-up door of FIG. 3. At its center, the lower horizontal bar 112 includes a pair of horizontal elongated L-shaped plates 156 terminating a lower end of the curtain 102. The plates 156 are connected via a hinge 158 and a middle plate 160. Connection of the middle plate 160 to ends of the plates 156 is made via shear pins 162. In case of impact on the curtain 102, the shear pins 162 will break, allowing the lower horizontal bar 112 to fold at the hinge 158, one of both edges 154 of the curtain 102 being released from the lateral guides 104. To reengage the curtain, an operator simply needs to raise the curtain 102 and reinsert the lower horizontal bar 112 in place between the horizontal member 110 and the curtain deflector 138. A deflection 164 at the top of the lateral guides 104 (see FIGS. 7 and 8) facilitates reinsertion of the horizontal member 110. The shear pins 162 should be replaced after lowering of the curtain.

Those of ordinary skill in the art will realize that the description of the door and of the curtain riser are illustrative only and are not intended to be in any way limiting. Other embodiments will readily suggest themselves to such persons with ordinary skill in the art having the benefit of the present disclosure. Furthermore, the disclosed door and curtain riser may be customized to offer valuable solutions to existing needs and problems related to limited available headroom for installation of roll-up door systems.

In the interest of clarity, not all of the routine features of the implementations of the door and of the curtain riser are shown and described. It will, of course, be appreciated that in the development of any such actual implementation of the door and of the curtain riser, numerous implementation-specific decisions may need to be made in order to achieve the developer's specific goals, such as compliance with application-, system-, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of door systems having the benefit of the present disclosure.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A roll-up door, comprising:
a curtain;
a pair of lateral guides configured to hold sides of the curtain when lowered; and
a horizontal member on which the curtain can be rolled when raised, a front edge of the horizontal member being aligned with a path formed by the lateral guides so that a top end of the curtain is tangent to the horizontal member when the curtain is fully lowered.

2. The roll-up door of claim 1, comprising a curtain deflector mounted at a forward angle from a top of the lateral guides, the curtain deflector being positioned above an opening of a door frame and being lower than a rolling axis of the horizontal member.

3. The roll-up door of claim 2, comprising a horizontal bar mounted at a bottom of the curtain, wherein the horizontal bar is retrieved between the horizontal member and the curtain deflector when the curtain is fully raised.

4. The roll-up door of claim 3, wherein a required headroom for installing the curtain deflector and the horizontal member, with the curtain fully rolled up, does not exceed 13 inches for a curtain height of 114 inches.

5. The roll-up door of claim 1, comprising a motorized drive operably connected to the horizontal member for rising and lowering the curtain.

6. The roll-up door of claim 5, comprising a controller of the motorized drive to control rising and lowering of the curtain.

7. The roll-up door of claim 6, comprising a sensor selected from the group consisting of a motion sensor, a photocell and a combination thereof, the sensor being operably connected to the controller.

8. The roll-up door of claim 5, wherein the motorized drive includes a sprocket driving a chain, the chain being connected to a sprocket mounted on the horizontal member.

9. The roll-up door of claim 1, wherein the horizontal member is a hollow tube.

10. The roll-up door of claim 1, wherein the lateral guides are configured to release the curtain upon application on the curtain of a force exceeding a predetermined threshold.

11. A low headroom curtain riser for a roll-up door having a curtain and a pair of lateral guides for the curtain, the curtain riser comprising:
a horizontal member on which the curtain can be rolled when raised, a front edge of the horizontal member being aligned with a path formed by the lateral guides so that a top end of the curtain is tangent to the horizontal member when the curtain is fully lowered.

12. The curtain riser of claim 11, comprising a curtain deflector mountable above an opening of a frame of the roll-up door, lower than a rolling axis of the horizontal member and inclined at a forward angle from a top of the lateral guides.

13. The curtain riser of claim 12, wherein space is provided between the curtain deflector and the horizontal member with the curtain fully rolled thereon for receiving a horizontal bar mounted at a bottom of the curtain.

14. The curtain riser of claim 13, wherein a required headroom for the curtain riser does not exceed 13 inches for a curtain height of 114 inches.

15. The curtain riser of claim 11, comprising a motorized drive operably connected to the horizontal member for rising and lowering the curtain.

16. The curtain riser of claim 15, comprising a controller of the motorized drive to control rising and lowering the curtain.

17. The curtain riser of claim 16, comprising a sensor selected from the group consisting of a motion sensor, a photocell and a combination thereof, the sensor being operably connected to the controller.

18. The curtain riser of claim 15, wherein the motorized drive includes a sprocket driving a chain, the chain being connected to a sprocket mounted on the horizontal member.

19. The curtain riser of claim 11, wherein the horizontal member is a hollow tube.
